(19) United States
(12) Patent Application Publication
(10) Pub. No.: US 2003/0051379 A1
(43) Pub. Date: Mar. 20, 2003

(54) Emergency visual and tactile exits system

(76) Inventor: Robert Edward Williams JR., Longwood, FL (US)

Correspondence Address: ROBERT E. WILLIAMS, JR., 2098 JUDITH PLACE, LONGWOOD, FL, 32779, US

(21) Appl. No.: 09/956,651

(22) Filed: Sep. 20, 2001

(51) Int. Cl. G09F 13/20

(52) U.S. Cl. 40/542; 40/570

(57) ABSTRACT

A visual and tactile emergency exit system comprising a series of signs having both visual and tactile components to guide a person to the nearest exit of a room. The visual components of each sign comprises the sign's shape and text incorporated in the face of the sign. The sign is constructed of a self-illuminating material. The tactile components of each sign comprises braille translations of the sign's message mounted on the face of the sign, a minimum sign thickness, and cut out or raised text on the face of the sign. The signs are positioned in strategic locations along a wall to indicate the direction to the nearest exit, whether a person must turn or continue traveling straight at a comer, and the location of the exit door. The signs are positioned on the lower portion of the wall so that they can be easily read or touched by a prone person.

### BACKGROUND OF THE INVENTION

1. Field of the Invention

The present invention relates to guidance systems installed in the interiors of the buildings for use in low visibility situations. More particularly, this invention relates to a system of signs strategically positioned throughout a building and having visual and tactile components that can guide a person to an exit in low light and low visibility situations.

2. Related Art

It is well established that it is desirable, and often legally required, for a building to have a means of informing its occupants of the direction to emergency exits and the locations of emergency equipment (i.e., fire extinguishers). This is especially true with a public building where the occupants may not be familiar with the building's layout and the location of its exits. Therefore, many public buildings have electrically illuminating signs that direct the occupants to the nearest exits. They may also have signs in strategic locations showing the layout of the building and the location of its exits. However, in emergency low-high situations, the aforementioned signs may not be visible to people attempting to evacuate the building. For example, the exit signs may lose power or be obscured by thick smoke. It is also well known that person evacuating a smoky room should keep low to the floor to avoid as much smoke as possible. Therefore, emergency exit signs that are now commonly in use are not readily visible to that person.

The system disclosed in this application is designed to be placed in interior corridors and rooms of a building. It is placed near the floor so that it will be readily visible to a person who is crawling or creeping along the floor as is commonly recommended in a fire/smoke environment. The system consists of signs that guide the person to the nearest exit and to fire extinguishers. The signs have text and symbols to allow the person to visual find his or her way out of the building when the room is not dark or completely obscured by smoke. If the room is dark, the signs will be illuminated to allow the person to read them. Or, if the person is sight-impaired, the signs' tactile design and inclusion of braille will allow the person to feel his or her way out of the building.

Other systems have been designed to serve the same basic function of guiding people out of a building in low-visibility situations. For example, U.S. Pat. No. 4,385,586 discloses a system of a three-dimensional, arrow shaped devices that are mounted on a wall to guide a user to an emergency exit. The devices have bumps of depressions that inform the person feeling them how many doors he or she must pass before reaching the exit door. One embodiment disclosed in the patent has the devices illuminated by an external power source. U.S. Pat. No. 6,025,773 discloses a system of three-dimensional objects that are mounted along the baseboards, floors, and exit door of a room. The objects point the direction to the nearest exit door and are spaced in relation to each other so that, as they get closer to the door, the spacing between them gets smaller. Also, the placing of three-dimensional blocks across a corridor informs the person feeling them that he or she must cross the corridor.

In the aforementioned patents, a building's occupants would have to be familiar with the design and meanings of the various symbols and their relative placements to take full advantage of their purpose. For example, if a person did not know the meaning of the bumps or depressions on the arrow-shaped device system, he or she might accidentally enter a dangerous room of the building (e.g., one filled with flames or gas), thinking that the door was an exit. Also, if the electrical supply to the devices was cut off, the devices would not illuminate to help the person find them

One purpose of the system disclosed in this application is to allow a person to readily identify its signs and ascertain their meaning. If the person is sight impaired, he or she can still ascertain the signs' meanings by the feeling the braille message incorporated thereon. Also, the signs have raised lettering or cut-out letters that will enable a person who can't see the signs and can't read braille to make out the signs' meaning by feeling the letters and symbols on the signs as well as the shapes of the signs themselves. Finally, the signs are constructed of a long-lasting, self illuminating material that is not dependent upon an external power source to illuminate it.

### SUMMARY OF THE INVENTION

The invention described herein is directed to a system of signs intended to guide a visually impaired person, or other person in a low visibility environment, out of a building in an emergency. The invention consists of five sign types, each having its own distinct and easy-to-understand message. A plurality of each sign type may be mounted on the interior walls of a building in strategic locations to guide people along predetermined escape routes to the nearest exits. The sign types comprise an arrow sign that indicates the direction to the nearest exit, a cross hallway sign that indicates that a corridor must be crossed to reach the nearest exit, a turn corner sign that indicates that the nearest exit is to the left or right, an exit sign indicates the presence of the exit door, and a fire extinguisher sign that indicates the presence of a fire extinguisher.

The signs all have a finite thickness that allows a person to feel them. The signs incorporate braille and cut out or raised lettering so a person can “read” the message if each sign by feeling it. Also, the signs are constructed of a long-lasting self illuminating material makes it visible in low light, or no light, situations.

### BRIEF DESCRIPTION OF THE DRAWINGS

FIG. 1 provides a perspective view of the described emergency exit system installed in the preferred arrangement in a building lobby with a cross-corridor.

FIG. 2 provides a perspective view of the described emergency exit system installed in the preferred arrangement in another room arrangement.

FIG. 3 provides a perspective view of the described emergency exit system installed in the preferred arrangement in a third room arrangement.

FIG. 4 provides a plan view of an arrow sign employed by the system.

FIG. 5 provides a plan view of a cross hall sign employed by the system.

FIG. 6 provides a plan view of a turn corer sign employed by the system.

FIG. 7 provides a plan view of an exit sign employed by the system.

FIG. 8 provides a plan view of a fire extinguisher sign employed by the system.

### DETAILED DESCRIPTION OF THE PREFERRED EMBOIDMENT

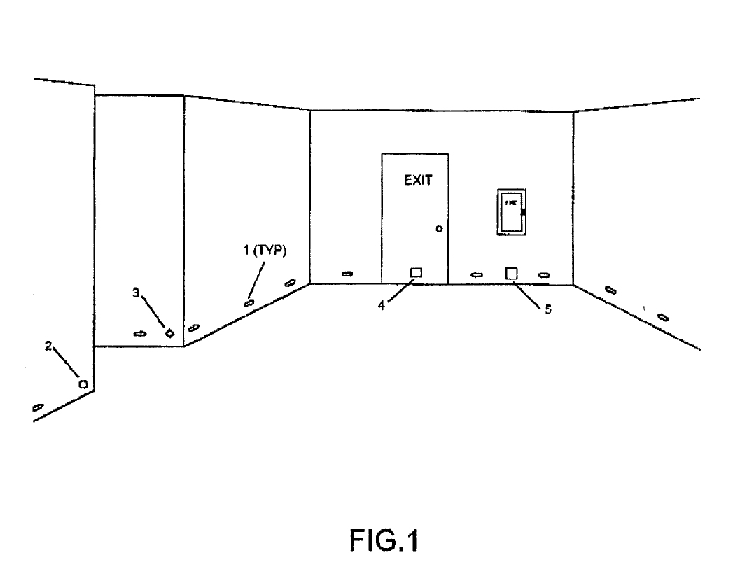

The invention consists of a plurality of signs placed in strategic locations throughout a building. FIGS. 1, 2 and 3 show the preferred embodiment of the emergency exit system installed in three different room arrangements, each having a connecting or cross corridor. The physical components of the system consist of five different sign types, each providing a different message to a person evacuating a building. As shown in FIGS. 1, 2 and 3, all of these signs are positioned on the wall close to the floor where they can easily be read or felt by a person evacuating the room in a prone position.

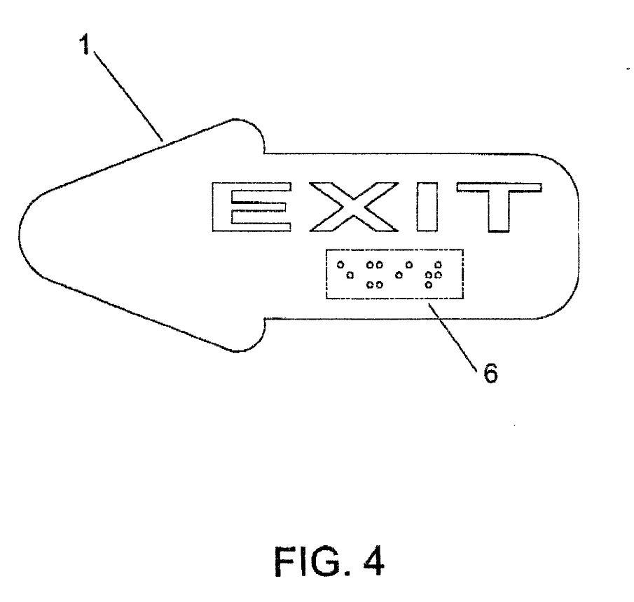

Looking at FIG. 1, arrow signs 1 are positioned strategically along the walls to guide a person in the proper direction. A detailed plan view of an arrow sign 1 is shown in FIG. 4. It is generally arrow-shaped and is pointed in the direction of the escape route to the nearest exit door. When a person encounters an arrow sign 1 while traveling along the wall, he or she can immediately read or feel the direction along the wall he or she must travel to reach the nearest exit as quickly as possible. At a minimum, there should be at least one arrow sign 1 positioned along midway along the length of each wall. The positioning and number of arrow signs 1 positioned along each wall will be at the discretion of the building owner or person installing the system. Of course, a person evacuating the room will be able to do so more quickly and easily if there were a greater number of arrow signs 1 positioned on each wall at closer intervals. In the preferred embodiment, the arrow signs 1 are positioned at intervals of two to four feet.

The preferred arrow sign 1 is at least 1/32 inch thick to enable a person to feel its shape. It has the word “EXIT” cut out or it so that a person tactilely feels the lettering in the sign. A braille strip 6 containing a braille translation of the word is also mounted on the face of the sign. In an alternative embodiment, the word “EXIT” may consist of raised non-illuminating letters mounted on the face of the sign.

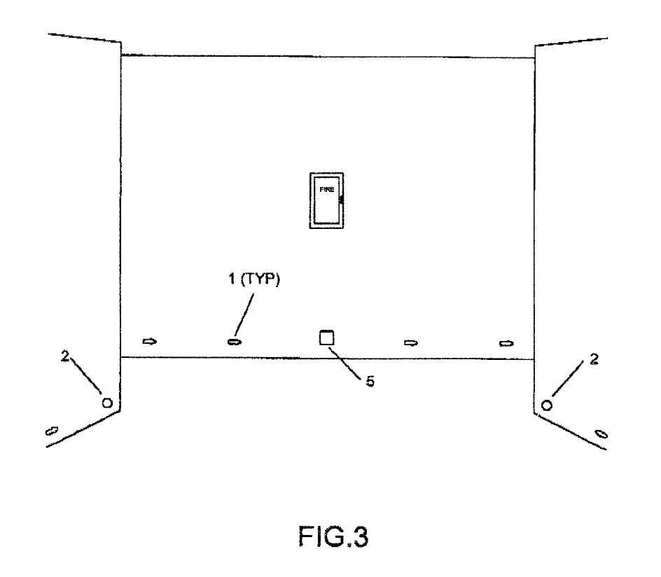

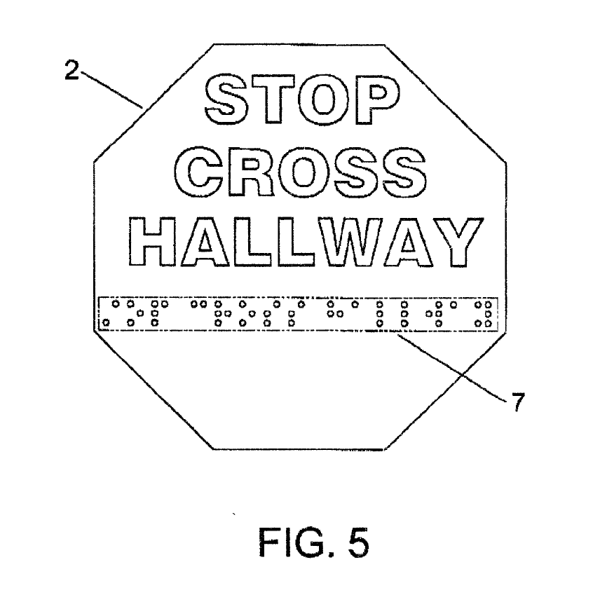

Looking at FIG. 3, cross hall signs 2 are positioned where a wall ends when it encounters a cross-corridor. A detailed plan view of a cross hall sign 2 is shown in FIG. 5. It is octagonal-shaped. When a person encounters a cross hall sign 2 at the end of a wall, he or she can immediately read or sense by touch that he or she must continue directly across the corridor to the opposite wall. In the preferred embodiment of the invention, an arrow sign 1 will be positioned on the wall across the corridor as shown in FIG. 3 to further guide the person in the proper direction to the nearest exit. Also, where another corner is located across the corridor as shown in FIG. 1, a turn corner sign 3 will further guide the person in the correct direction as discussed below.

The preferred cross hall sign 2 is at least 1/32 inch thick to enable a person to fell its shape. It has the words “STOP CROSS HALLWAY” cut out of it so that a person can tactilely feel the lettering in the sign. A braille stripe 7 containing a braille translation of the words “STOP CROSS HALLWAY” is also mounted on the face of the sign. In an alternative embodiment, the words “STOP CROSS HALLWAY” may consist of raised non-illuminating letters mounted on the face of the sign.

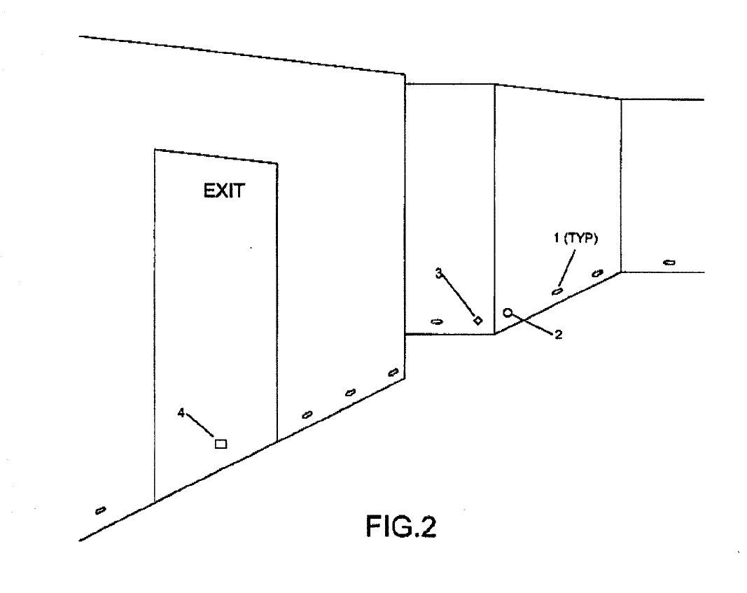

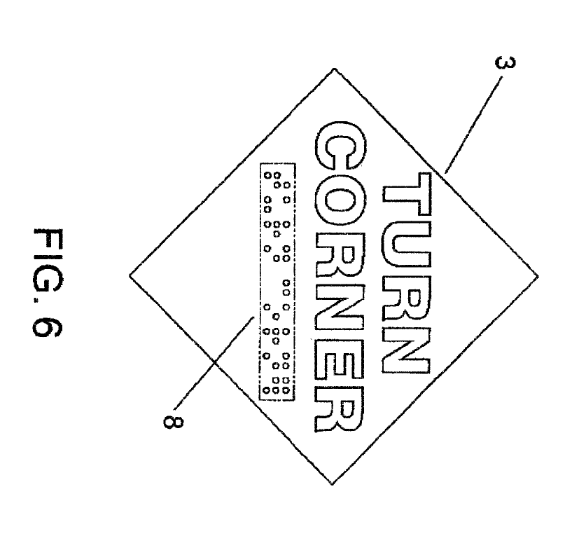

Returning to FIG. 1, turn corner signs 3 are positioned where a wall ends when it encounters a cross-corridor and a person must turn the corner (i.e., not cross the hall or room) to find the nearest exit. A detailed plan view of a turn corner sign 3 is shown in FIG. 6. It is diamond-shaped. When a person encounters a turn corner sign 3 while traveling along the wall, he or she can immediately read or sense by touch that he or she must turn left or right to reach the nearest exit. The direction that the person must turn can be determined by a sign mounted on the other side of the corner. For example, referring to FIG. 1, if the person encounters the turn that the escape route is to the left. Alternatively, if the person reached around the corner and felt a cross hall sign 2 as shown in FIG. 2, he or she would know that the escape route was to the right and would have to cross the corridor to find the nearest exit.

The preferred turn corner sign 3 is at least 1/32 inch thick to enable a person to feel its shape. It has the words “TURN CORNER” cut out of it so that a person can tactilely feel the lettering in the sign. A braille strip 8 containing a braille translation of the words “TURN CORNER” is also mounted on the face of the sign. In an alternative embodiment, the words “TURN CORNER” may consist of raised non-illuminating letters mounted on the face of the sign.

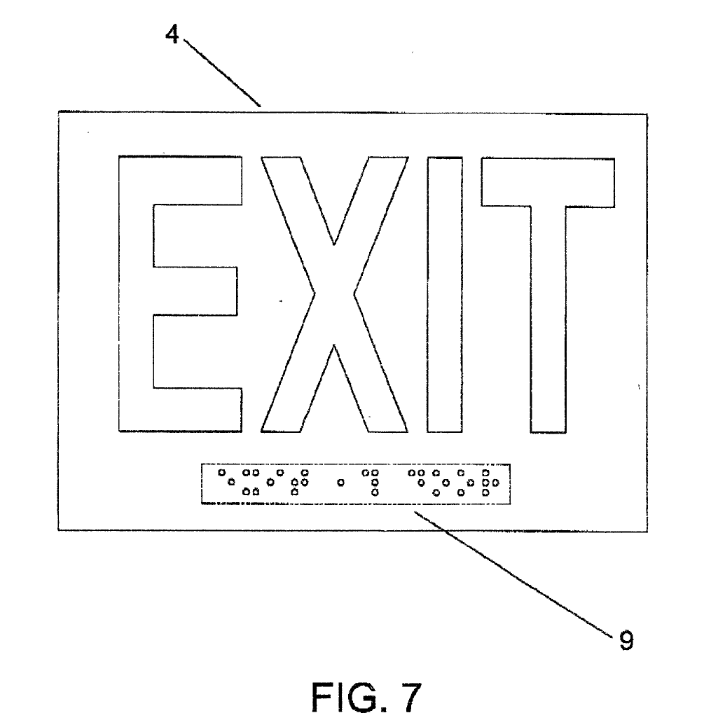

Returning to FIG. 1, an exit sign 4 is positioned on the exit door near the floor. A detailed plan view of an exit sign 4 is shown in FIG. 7. It is rectangular. When a person encounters a door while traveling along the wall, he or she can immediately verify that the door is an exit door by reading or touching the exit sign 4 mounted thereon.

The preferred exit sign 4 is at least 1/32 thick to enable a person to fell its shape. It has the word “EXIT” cut out of it so that a person can tactilely feel the lettering in the sign. A braille strip 9 containing a braille translation of the word “EXIT” is also mounted on the face of the sign. In an alternative embodiment, the word “EXIT” may consist of raised non-illuminating letters mounted on the face of the sign.

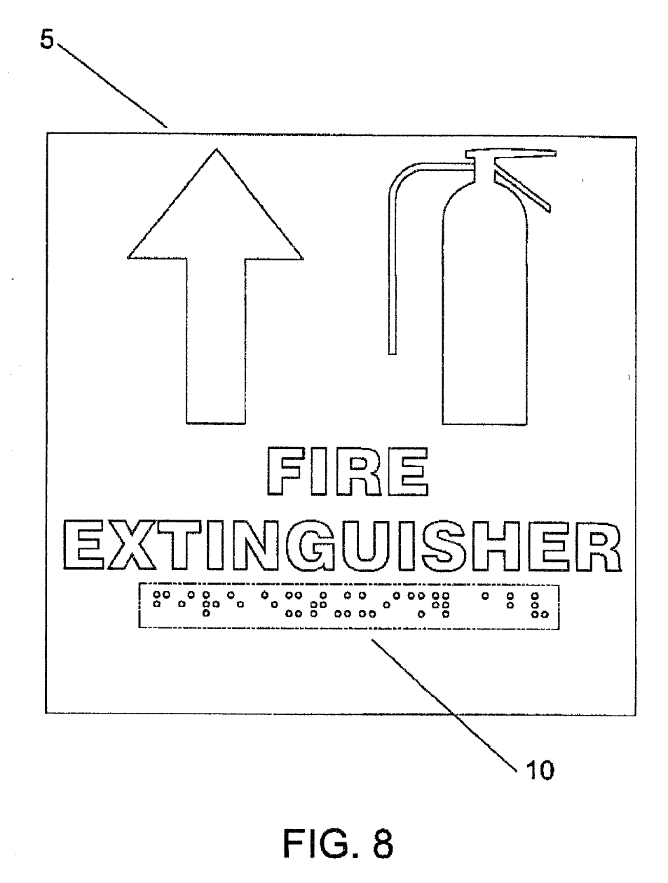

Returning to FIG. 1, a fire extinguisher sign 5 is positioned on the wall directly underneath a fire extinguisher. A detailed plan view of a fire extinguisher sign 5 is shown in FIG.8. It is square. When a person encounters a fire extinguisher sign 5 while traveling along the wall, he or she will know that a fire extinguisher is located on the wall directly above by reading or touching the sign.

The preferred fire extinguisher sign 5 is at least 1/32 inch think to enable a person to feel its shape. It has the words “FIRE EXTINGUISHER” and a graphical representation of a fire extinguisher cut out of it so that a person can tactilely feel the lettering and symbol in the sign. A braille strip 10 containing a braille translation of the words “FIRE EXTINGUISHER” is also mounted on the face of the sign. In an alternative embodiment, the text and symbol may consist of raised letters and a raised symbol mounted on the face of the sign. The raised letters and raised symbol are made of a non-illuminating material.

In the preferred embodiment of the invention, each of the signs 1, 2, 3, 4 and 5 are constructed of a long-lasting, self-illuminating material such as luminescent film manufactured by 3M. After being exposed to ambient lighting conditions such as those found in an office building corridor or a school hallway, the signs will remain illuminated for periods of up to eight hours after the lights are turned off.

While the preferred embodiment of the present invention is described above, it should be understood that it has been presented by way of example and not limitation. it will become apparent to those skilled in the are that equivalent alternative embodiments are possible. It is intended that all such alternative embodiments shall be covered by the claims set forth herein.

I claim:

1. A visual and tactile emergency exit system for use in low visibility situations to guide an individual through a room to an exit door, said emergency exit system comprising:
a plurality of first signs positioned on the walls of said room, said first signs visually and tactilely indicating the direction to proceed to said exit door;
a plurality of second signs positioned on the walls of said room, said second signs visual and tactilely indicating a cross-corridor that must be crossed to reach said exit door;
a plurality of third signs positioned on the walls of said room, said third signs visually and tactilely directing a person to turn a corner to reach said exit door; and
a plurality of fourth sign positioned on said exit door, said fourth sign visually and tactilely indicating the locations of said exit door.

2. The emergency exit system of claim 1, further compromising a plurality of fifth signs positioned on the walls of said room, said fifth signs visually and tactilely indicating the location of fire extinguishers;

3. The emergency exit system of claim 1 wherein said first signs, second signs, third signs, and fourth sign are positioned less then eighteen inches above the floor of said room.

4. The emergency exit system of claim 1 wherein said first signs, second signs, third signs, and fourth sign are at least 1/32 inch thick; said first signs, second signs, third signs, and fourth sign have text on their faces indicating the meaning of each sign; and said first signs, second signs, third signs, and fourth sign have braille strips attached on their faces indicating the meaning of each sign.

5. The emergency exit system of claim 4 wherein said text is cut out of said first signs, second signs, third signs, and fourth sign.

6. The emergency exit system of claim 4 wherein said text compromises raised letters that are at least 1/32 inch thick.

7. The emergency exit system of claim 5, wherein said first signs, second signs, third signs, and fourth sign are constructed of a self-illuminating material.

8. The emergency exit system of claim 7, wherein said first signs, second signs, third signs, and fourth sign are positioned less than eighteen inches above the floor of said room.

9. The emergency exit system of claim 6, wherein the faces of said first signs, second signs, third signs, and fourth sign are constructed of a self-illuminating material and said raised letters are constructed of a non-illuminating material.

10. A visual and tactile emergency exit system for use in low visibility situations to guide an individual through a room to an exit door, said emergency exit system comprising:
a plurality of first signs positioned on the walls of said room, said first signs visually and tactilely indicating the direction to proceed to said exit door, being essentially arrow-shaped, having the word “EXIT” cut out of the face of each said first sign, and having the braille translation of the word “EXIT” mounted on the face of each first sign;
a plurality of second signs positioned on the walls of said room, said second signs visually and tactilely indicating a cross-corridor that must be crossed to reach said exit door, being essentially octagonal-shaped, having the words “STOP CROSS HALLWAY” cut out of the face of each said second sign, and having the braille translation of the words “STOP CROSS HALLWAY” mounted on the face of each said second sign;
a plurality of third signs positioned on the walls of said room, said third signs visually and tactilely directing a person to turn a corner to reach said exit door, being essentially diamond-shaped, having the words “TURN CORNER” cut out of the face of each said third sign, and having the braille translation of the words “TURN CORNER cut out of the face of each said third sign; and
a fourth sign positioned on said exit door, said fourth sign visually and tactilely indicating the location of said exit door, being essentially rectangular-shaped, having the word “EXIT” cut out of the face of each said fourth sign, and having the braille translation of the word “EXIT” mounted on the face of each said fourth sign.

11. The emergency exit system of claim 10, further comprising a plurality of fifth signs positioned on the walls of said room, said fifth signs visually and tactilely indicating the location of fire extinguishers, being essentially square-shaped, having the words “FIRE EXTINGUISHER” cut out of the face of each said fifth sign, and having the braille translation of the words “FIRE EXTINGUISHER” mounted on the face of each said fifth sign.

12. The emergency exit system of claim 10 wherein said first signs, second signs, third signs, and fourth sign are positioned less than eighteen inches above the floor of said room.

13. The emergency exit system of claim 10 wherein said words on said first signs, said words on said second signs, said words on said third signs, and said words on said fourth sign comprise raised letters mounted on the faces of said first signs, said second signs, said third signs, and said fourth signs, said raised letters be at least 1/32 inch thick.

14. The emergency exit system of claim 10, wherein said first signs, said second signs, said third signs, and said fourth sign are constructed of a self-illuminating material.

15. The emergency exit system of claim 13, wherein the faces of said first signs, said second signs, said third signs, and said fourth sign are constructed of a self-illuminating material and said raised letters are constructed of a non-illuminating material.

16. The emergency exit system of claim 14 wherein said first signs, second signs, third signs, and fourth sign are positioned less than eighteen inches above the floor of said room.
